(19) United States
(12) Patent Application Publication
(10) Pub. No.: US 2017/0235747 A1
(43) Pub. Date: Aug. 17, 2017

(54) Electronic Document and Electronic File

(71) Applicant: Kim Seng KEE, Kuala Lumpur (MY)

(72) Inventors: Kim Seng Kee, Kuala Lumpur (MY); Keong Hway Chhua, Kuala Lumpur (MY)

(21) Appl. No.: 15/518,868

(22) PCT Filed: Oct. 13, 2015
(86) PCT No.: PCT/MY2015/050123

§ 371 Date: Apr. 13, 2017

(30) Foreign Application Priority Data
Oct. 13, 2014 (MY) PI2014703013

(51) Int. Cl. G06F 17/30; G06F 17/24

(52) U.S. Cl. CPC G06F 17/30091; G06F 17/30011; G06F 17/248

(57) ABSTRACT

A system to emulate manual filing system by storing and processing document that operates on Relational Database Management System (RDBMS), comprising; a String Template (1) having at least one details of document number, number of sections and number of rows defined based on at least one Input; a String Module (2) for generate a Electronic Document (eDoc) (11) having at least one Electronic Document Identifier (eDoc-Identifier), Section and Rowtype by validating the document number, number of sections and number of rows based on the String Template (1); and a Extraction Module (3) for extracting the Electronic Document (eDoc) (11) having at least one Electronic Document Identifier (eDoc-Identifier), Section, Rowtype and Column for retrieval process.

### FIELD OF INVENTION

The proposed invention relates to a system and method to emulate manual filing system by storing and processing document that operates on Relational Database Management System (RDBMS).

### BACKGROUND ART

An age of integration—in which data, images, audio and video are used together, often in the same document or process—has generated a real need for an efficient, seamless and intuitive means of storing and retrieving all this digital information. This usually means having to manage complex relationships between stored entities. Traditional methods involve breaking up and placing parts of the data into various tables so that a relational database management system (RDBMS) can handle them: this highly complex task involves designing and managing relationships between data items stored in the various tables.

Software development for enterprise is complex and time consuming as it may require hundreds of man years. The main contributor to complexity is the tens of thousands of tables necessary in an enterprise system. The design of the database together with the primary and foreign keys complicates SDLC. Also tables require extra programs to link and split documents.

The legacy system that uses RDBMS as its database cannot store documents and folios, the documents and folios must be split into tables with different primary keys and foreign keys to be able to store onto RDBMS. The thousands of table designs must include all input tables, intermediate tables and output tables is a very complicated undertaking.

The thousands of tables complicate systems development life cycle (SDLC) & complicates data managements. Therefore, to provide a one view of customer folio, general ledger folio, stock folio, etc. is a difficult effort as the data must be transformed between each process (web, transmission, storage, processing (batch, on-line, BPM), data-warehousing, data-mining, output.

In Legacy system, it is difficult to integrate data & system because it is usually developed by different group as Legacy systems involve thousands of tables. The Documents, Flows, Business Rules & Codes are often lost in the process, therefore difficult for business personnel to talk to the computer people.

Because of the complexity, software changes are slow, complex & expensive, the dateline are difficult to meet. What is really needed is an efficient system which stores structured, semi-structured and unstructured data (and the schema which describes the data), and manages the relationships between data items.

Therefore an invention is proposed a system to emulate manual filing system by storing and processing electronic document that operates on Relational Database Management System (RDBMS).

### SUMMARY OF INVENTION

The present invention provides a system to emulate manual filing system by storing and processing document that operates on Relational Database Management System (RDBMS), comprising; a String Template having at least one details of document number, number of sections and number of rows defined based on at least one Input; a String Module for generate a Electronic Document (eDoc) having at least one Electronic Document Identifier (eDoc-Identifier), Section and Rowtype by validating the document number, number of sections and number of rows based on the String Template; and a Extraction Module for extracting the Electronic Document (eDoc) having at least one Electronic Document Identifier (eDoc-Identifier), Section, Rowtype and Column for retrieval process.

A further aspect of the present invention provides a system to emulate manual filing system by storing and processing document that operates on Relational Database Management System (RDBMS) further comprising; a Retrieval Module for retrieving at least one Retrieved Data from the data of Electronic Document (eDoc) stored in the database based on at least one Input of the Section, Rowtype and Column; a Updating Module for updating the Retrieved Data of Electronic Document (eDoc) and store at least one Updated Data to the database based on the Input of Section, Rowtype and Column defined; and a Formation Module for forming the updated Electronic Document (eDoc) by retrieving the Updated Data based on the Input of Section, Rowtype and Column.

Another aspect of the present invention provides a system to emulate manual filing system by storing and processing document that operates on Relational Database Management System (RDBMS) further comprising; a Paging Module for append Electronic Document (eDoc) in the database into at least one Electronic File (eFile) according to a predefined Page limit; and a Index Module for forming at least one Index to the Electronic File (eFile) based-on document identifier, date, end sequence number, document status, document offset and document length.

Another aspect of the present invention provides a system to emulate manual filing system by storing and processing document that operates on Relational Database Management System (RDBMS) further comprising; a Read Module for retrieving the Index and at least one Data Relative Page (Page 0) of the Electronic File (eFile) based on at least one Read Input to at least one Output.

Another aspect of the present invention provides a system to emulate manual filing system by storing and processing document that operates on Relational Database Management System (RDBMS) further comprising; a Mapping Module for updating at least one Retrieved Data based on at least one Mapping Input by determining the Electronic File (eFile) using the Read Module to retrieve the Retrieved Data of Electronic Document (eDoc) using the Retrieval Module, in which the Updating Module update the Retrieved Data to the database and forming the Retrieved Data into the Electronic Document (eDoc) using the Formation Module for updating into at least one Electronic File (eFile) using Paging Module and forming at least one Index using the Index Module.

Further, the Mapping Input further comprising; at least one Mapping Instruction having predefined mapping instruction; and at least one Source Data for updating the Retrieved Data of Electronic Document (eDoc).

The present invention also provides a method to emulate manual filing system by storing and processing document that operates on Relational Database Management System (RDBMS), comprising steps of; creating a template using a String Template by defining a new document and indicate number of sections and number of rows required, which will be defined by an input from a user or a database. generating a Electronic Document (eDoc) having at least one Electronic Document Identifier (eDoc-Identifier), Section and Rowtype by validating the document number, number of sections and number of rows based on the String Template; and extracting the Electronic Document (eDoc) having at least one Electronic Document Identifier (eDoc-Identifier), Section and Rowtype for retrieval process using a Extraction Module.

Further, the extracting the Electronic Document Identifier (eDoc-Identifier) further comprising steps of; validating if there is section defined in the input; creating a new section and define or classify (label) the section if it is the 1^{st} Section in the input, validating if there is any Rowtype defined in the input, If there is Rowtype defined in the input, creating a new Rowtype based on a Predefined Dictionary, If there is Rowtype defined in the input; validating if there is any other Section or Rowtype defined in the input for further processing; and generating the eDoc template string with a document number, if there no other Section or Rowtype defined in the input

Another aspect of the present invention provides a method according to claim 7, further comprising steps of; retrieving at least one Retrieved Data from the data of Electronic Document (eDoc) stored in the database based on at least one Input of the Section, Rowtype and Column using a Retrieval Module; updating the Retrieved Data of Electronic Document (eDoc) and store at least one Updated Data to the database based on the Input of Section, Rowtype and Column defined using a Updating Module; and forming the updated Electronic Document (eDoc) by retrieving the Updated Data based on the Input of Section, Rowtype and Column using a Formation Module.

Further, retrieving a Electronic Document (eDoc) String using a Retrieval Module further comprising steps of; validating if there is section defined in the eDoc; splitting the section into Rowtype for further processing; splitting Rowtype into column of data; and storing the column of data into a Database.

Further, the column of data will be stored into a Database further comprising steps of; validating if there is any other Section or Rowtype defined in the input for further processing; validating If there no other Section or Rowtype defined in the input; and processing for retrieval of data in the Column.

Further, Validating Section and Rowtype using the Updating Module further comprising steps of; Validating if valid section is determined; Validating if valid

Rowtype is determined; locating the row index and column index; updating to the located row index and column index based on the input received; and Storing the updated data will be stored into a Database.

Another aspect of the present invention provides a method for storing and processing document that operates on Relational Database Management System (RDBMS) further comprising appending Electronic Document (eDoc) in the database into at least one Electronic File (eFile) according to a predefined Page limit using a Paging Module; and forming at least one Index to the Electronic File (eFile) based-on document identifier, date, end sequence number, document status, document offset and document length using a Index Module.

Another aspect of the present invention provides a method for storing and processing document that operates on Relational Database Management System (RDBMS) further comprising retrieving the Index and at least one Data Relative Page (Page 0) of the Electronic File (eFile) based on at least one Read Input to at least one Output using a Read Module.

Another aspect of the present invention provides a method for storing and processing document that operates on Relational Database Management System (RDBMS) further comprising updating at least one Retrieved Data using a Mapping Module based on at least one Mapping Input by determining the Electronic File (eFile) using the Read Module to retrieve the Retrieved Data of Electronic Document (eDoc) using the Retrieval Module, in which the Updating Module update the Retrieved Data to the database and forming the Retrieved Data into the Electronic Document (eDoc) using the Formation Module for updating into at least one Electronic File (eFile) using Paging Module and forming at least one Index using the Index Module.

Further, the Mapping Input further comprising; defining the Electronic File (eFile) location using at least one Mapping Instruction having predefined mapping instruction; and updating the Retrieved Data of Electronic Document (eDoc) using at least one Source Data.

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF PREFERRED EMBODIMENT

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

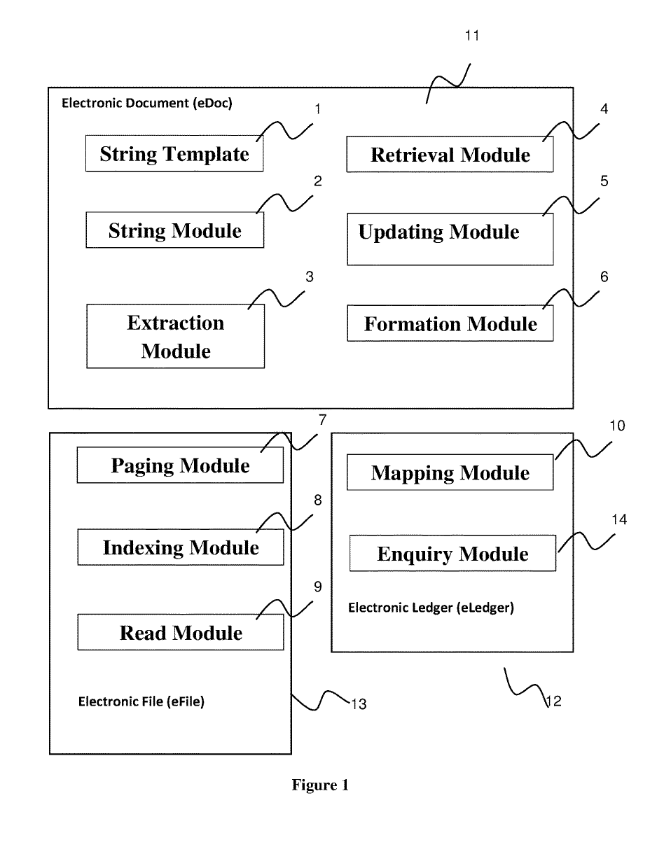

FIG. 1 illustrates overall architecture of the Electronic Document (eDoc) and Electronic File (eFile).

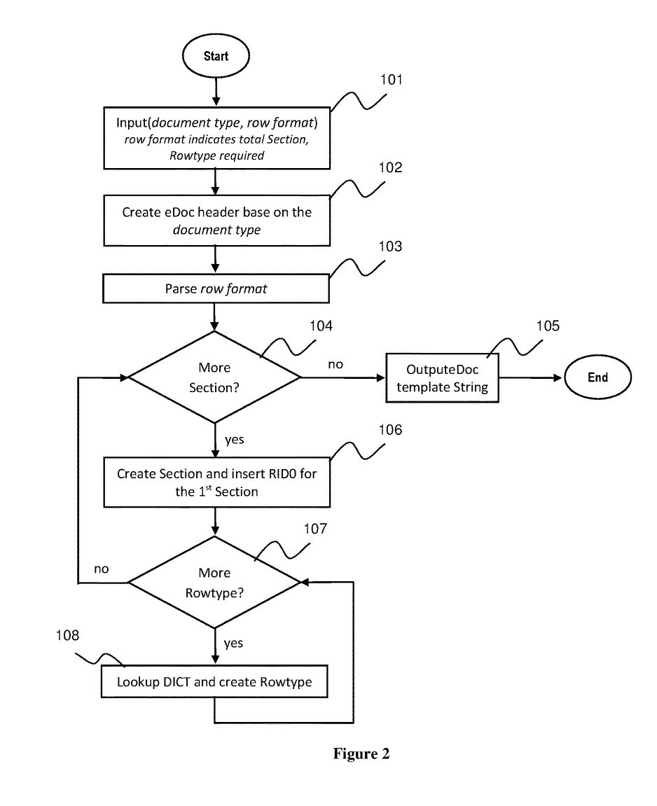

FIG. 2 illustrates a flow chart for creating a Electronic Document (eDoc) template string.

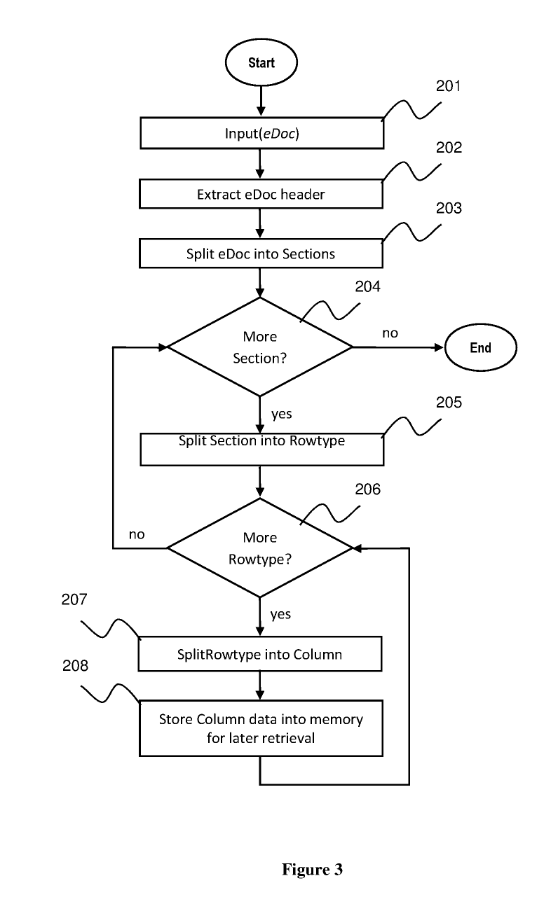

FIG. 3 illustrates a flow chart of extracting process from a Electronic Document (eDoc) String.

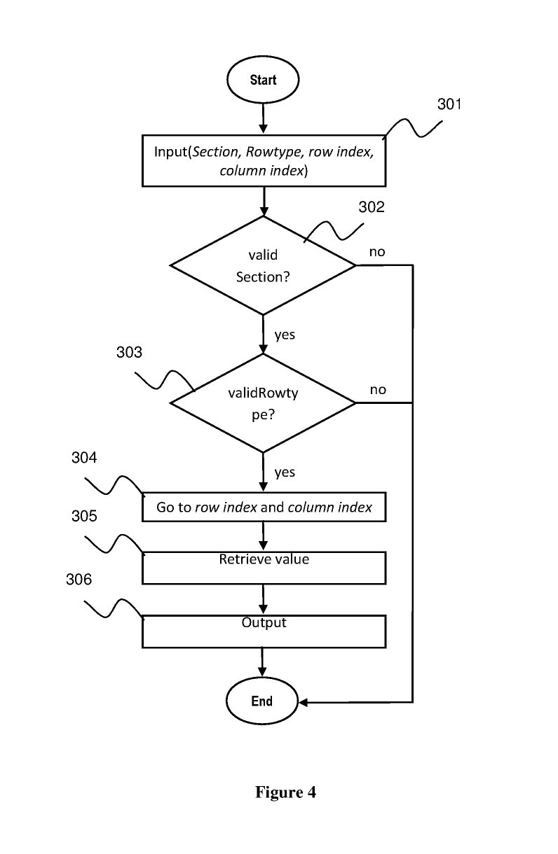

FIG. 4 illustrates a flow chart of retrieving process for data from the Column of extracted Electronic Document (eDoc).

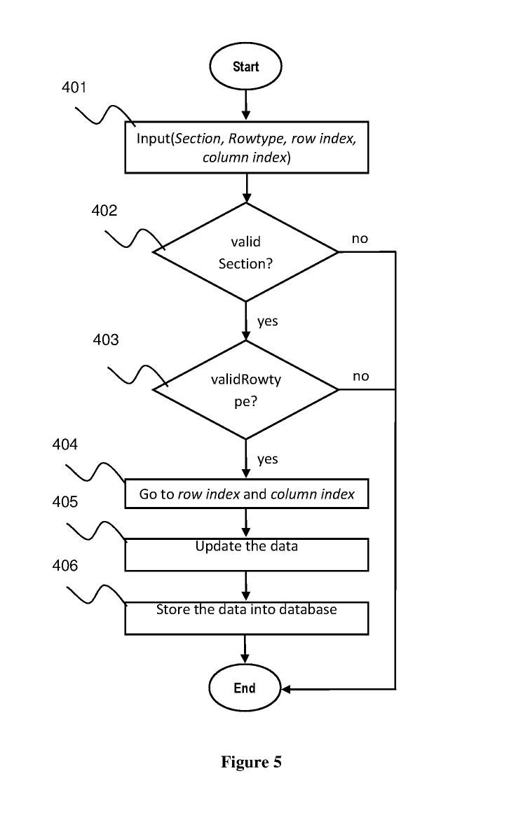

FIG. 5 illustrates a flow chart of updating process for data from the retrieved row index and column index.

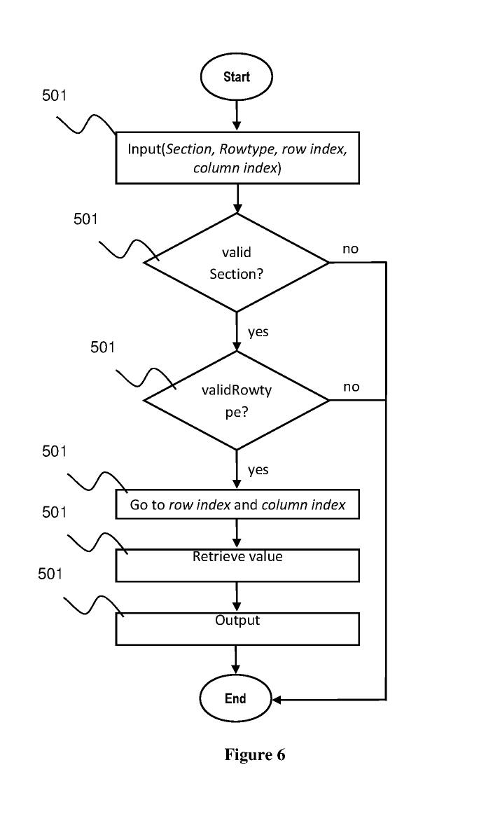

FIG. 6 illustrates a flow chart of uploading process for a Electronic Document (eDoc) String.

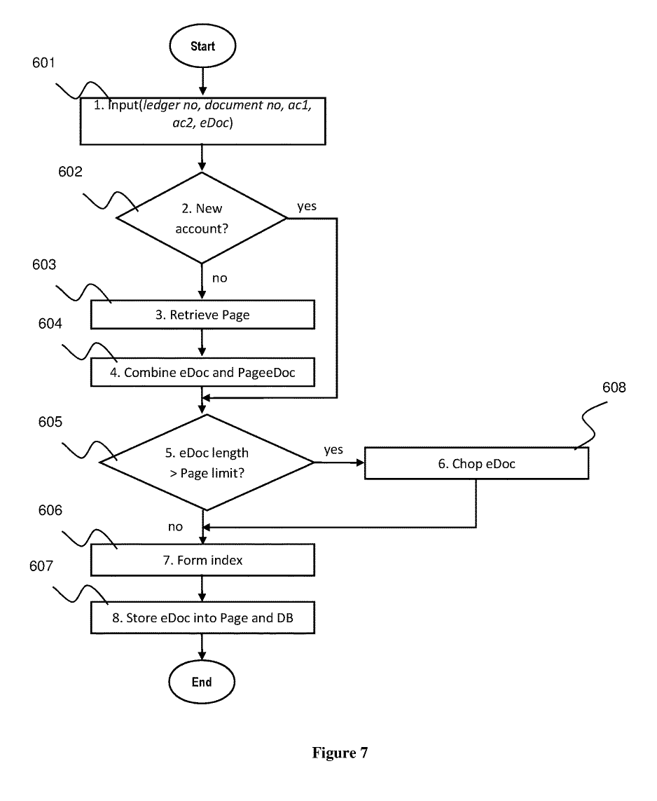

FIG. 7 illustrates a flow chart of paging process of a Electronic Document (eDoc) for a Electronic File (eFile).

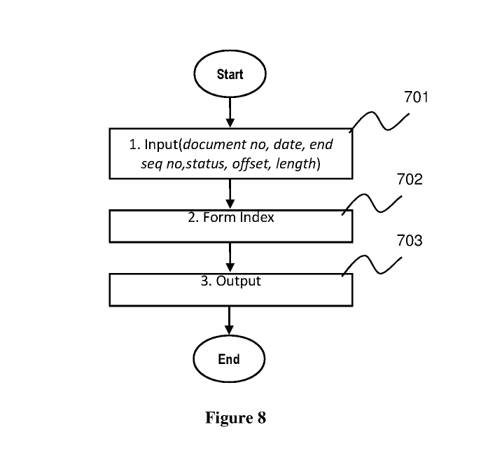

FIG. 8 illustrates a flow chart of indexing process of a Electronic Document (eDoc) for a Electronic File (eFile).

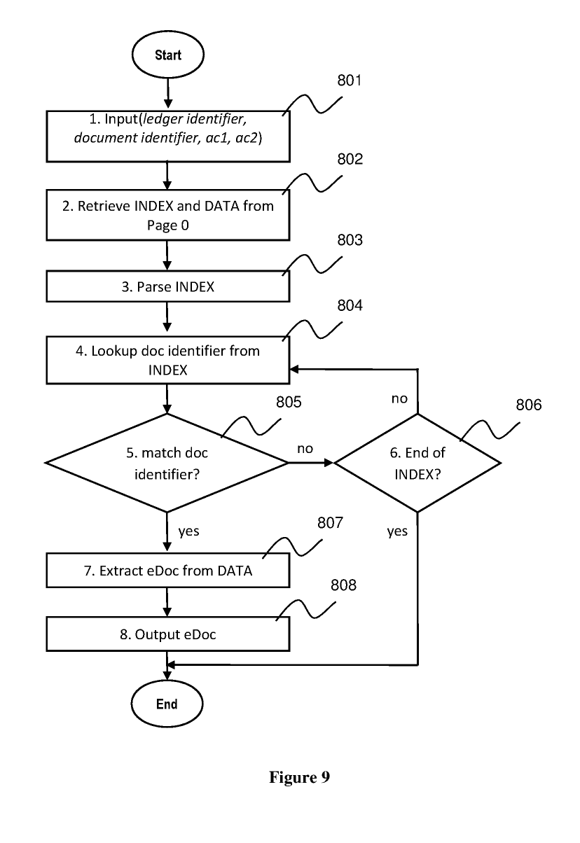

FIG. 9 illustrates a flow chart of reading process of a Electronic Document (eDoc) for a Electronic File (eFile).

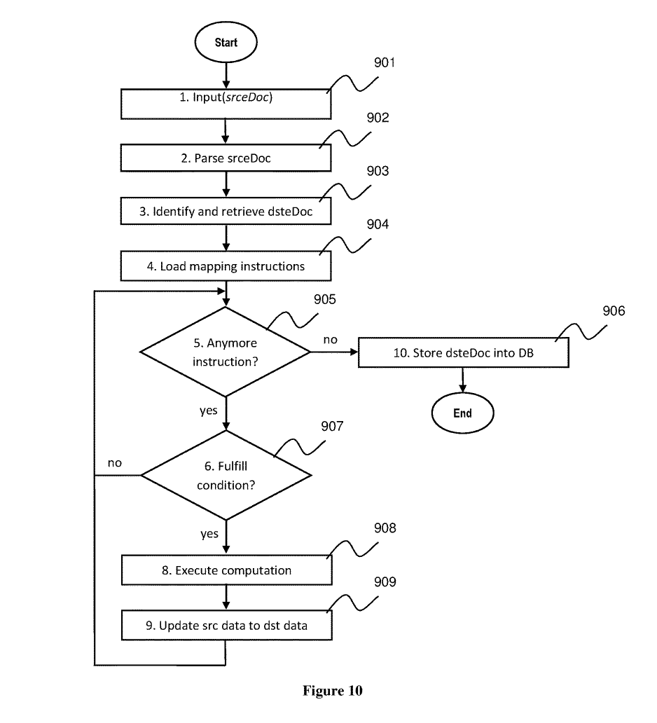

FIG. 10 illustrates a flow chart of Mapping process of a Electronic Document (eDoc) for a Electronic File (eFile).

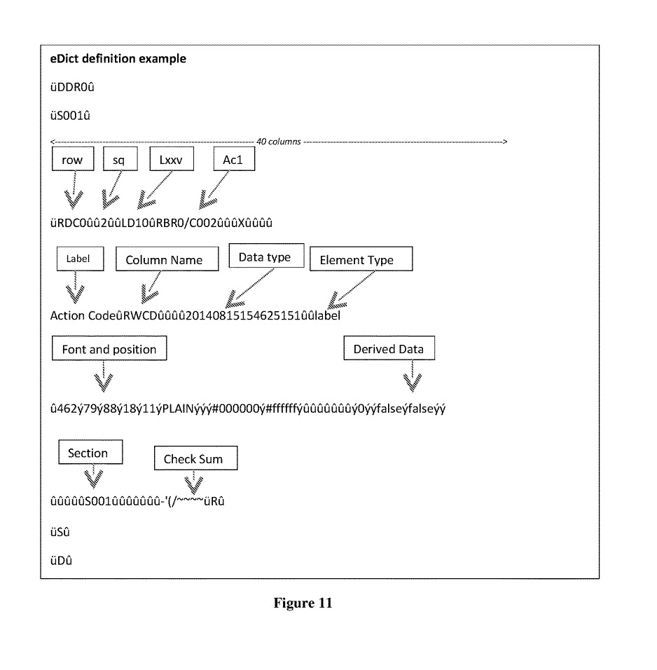

FIG. 11 illustrates an example of Electronic Dictionary (eDict) or metadata is used to describe the attribute/behavior in a string.

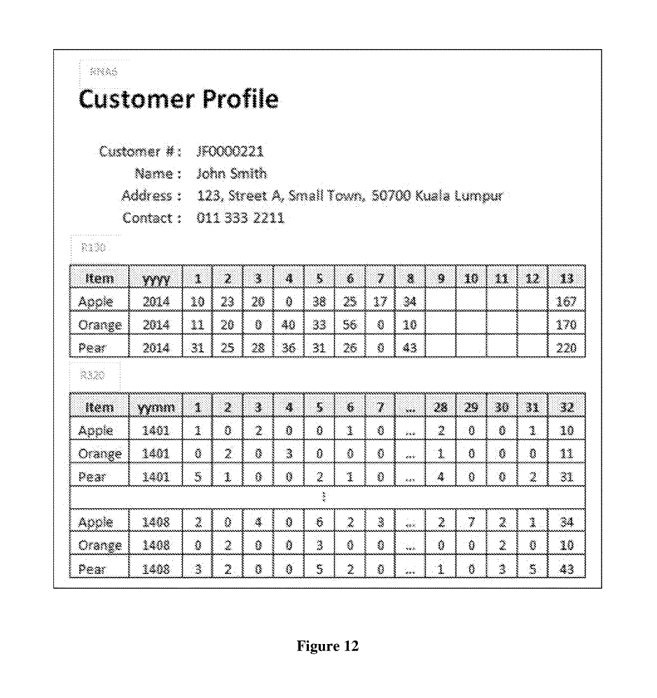

FIG. 12 illustrates an example eLedger containing details of a customer profile and item details.

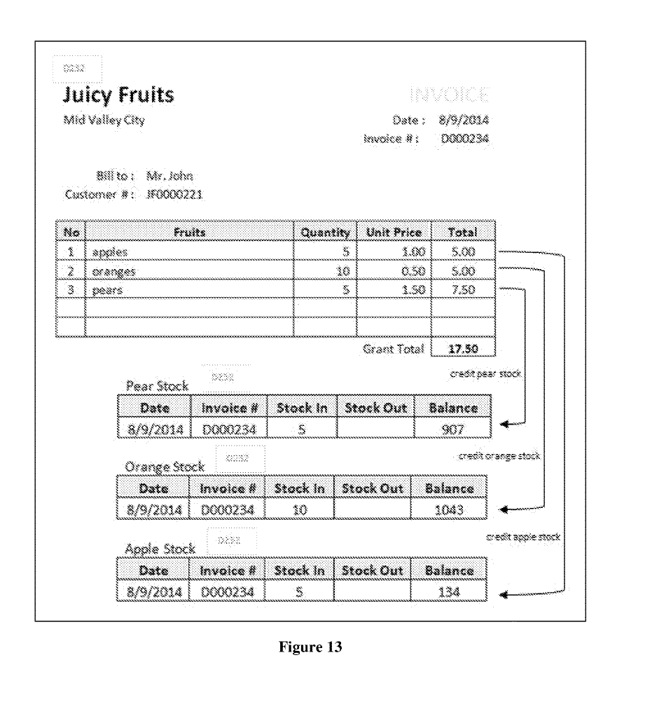

FIG. 13 illustrates an example creation of subDoc based on the example as in FIG. 12.

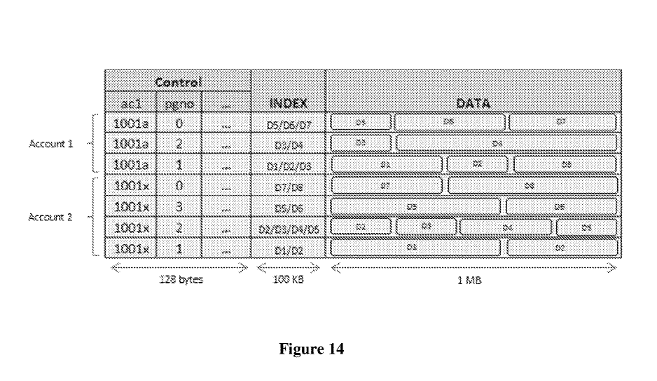

FIG. 14 illustrates an example of how eFiles store in a RDBMS Table.

### DETAILED DESCRIPTION OF THE PREFERRED EMBODIMENTS

The proposed invention relates to a system and method to emulate manual filing system by storing and processing document that operates on Relational Database Management System (RDBMS).

Data is stored in a format called Electronic Document (eDoc), which serves as the display, storage, processing, and transmission format throughout the systems development life cycle, without transformation at any stage. Data can be imported from or exported to any format including PDF, XML, XLS and CSV.

An Electronic File (eFile) stores eDocs (with all data file types) on a database (RDBMS). Filing System predominantly utilizes the database read, write and index functions only. Therefore it can utilise almost all popular RDBMS, and if necessary can handle any customised, in-house database systems.

As illustrated in FIG. 1, the system to emulate manual filing system for storing and processing document that operates on Relational Database Management System (RDBMS), comprising; a String Template (1) having at least one details of document number, number of sections and number of rows defined based on at least one Input; a String Module (2) for generate a Electronic Document (eDoc) (11) having at least one Electronic Document Identifier (eDoc-Identifier), Section, Rowtype and Column by validating the document number, number of sections and number of rows based on the String Template (1); and a Extraction Module (3) for extracting the Electronic Document Identifier (eDoc-Identifier), Section, Rowtype and Column of Electronic Document (eDoc) (11) generated by the String Module (2) for retrieval process. The system also includes a Retrieval Module (4) for retrieving at least one Retrieved Data from the data of Electronic Document (eDoc) (11) stored in the database based on at least one Input of the Section, Rowtype and Column; a Updating Module (5) for updating the Retrieved Data of Electronic Document (eDoc) (11) and store at least one Updated Data to the database based on the Input of Section, Rowtype and Column defined; and a Formation Module (6) for forming the updated Electronic Document (eDoc) (11) by retrieving the Updated Data based on the Input of Section, Rowtype and Column. Further, the system has a Paging Module (7) for append Electronic Document (eDoc) (11) in the database into at least one Electronic File (eFile) (13) according to a predefined Page limit; a Indexing Module (8) for forming at least one Index to the Electronic File (eFile) (13) based-on document identifier, date, end sequence number, document status, document offset and document length; and a Read Module (9) for retrieving the Index and at least one Data Relative Page (Page 0) of the Electronic File (eFile) (13) based on at least one Read Input to at least one Output. In addition the system further includes a Mapping Module (10) for updating at least one Retrieved Data based on at least one Mapping Input by determining the Electronic File (eFile) (13) using the Read Module (9) to retrieve the Retrieved Data of Electronic Document (eDoc) (11) using the Retrieval Module (4), in which the Updating Module (5) update the Retrieved Data to the database and forming the Retrieved Data into the Electronic Document (eDoc) (11) using the Formation Module (6) for updating into at least one Electronic File (eFile) (13) using Paging Module (7) and forming at least one Index using the Indexing Module (8); and a Enquiry Module (14) for retrieving a pluralities of Electronic Document (eDoc) (11) information using a Mapping Module (10) based on at least one Information for the Electronic Document Identifier (eDoc-Identifier), Section, Rowtype and Column of Electronic Document (eDoc) (11), in which the retrieved Electronic Document (eDoc) (11) information having at least one file history display into at least one list form.

As illustrated in FIG. 2, the system or module are initiated by creating a template by defining a new document and indicate number of sections and number of rows required, which will be defined by an input from a user or a database. Then, the system or module creates a Electronic Document Identifier (eDoc-Identifier) based on the document number defined from the input. Thereafter, the system or module interprets the eDoc Identifier for further processing, where the system or module validates how many sections or Rowtype defined in the input to form a eDoc template string. If there is section defined in the input, the system or module will create a new section and define or classify (label) the section if it is the 1^{st} Section in the input. Then the system or module validates is there any Rowtype defined in the input. If there is Rowtype defined in the input, the system or module will create a new Rowtype based on a Predefined Dictionary. The system or module further will validates if there is any other Section or Rowtype defined in the input for further processing. If there no other Section or Rowtype defined in the input, the system or module will further process to generate the eDoc template string with a document number.

As illustrated in FIG. 3, the system or module are initiated by retrieving a Electronic Document (eDoc) String for extraction process, where the system extract a eDoc Identifier from the eDoc String having a document number. Then, the system will determine the section of the eDoc Identifier predefined in the eDoc String. If there is section defined in the eDoc Identifier, the system will split the section into Rowtype for further processing. Then, the Rowtype will split into column of data, where the column of data will be stored into a Database. The system further will validates if there is any other Section or Rowtype defined in the input for further processing. If there no other Section or Rowtype defined in the input, the system will further process for retrieval of data in the Column.

As illustrated in FIG. 4, the system or module are initiated by receiving input from a database or a user. Then, the system validates the Section and Rowtype based on the receiving input for retrieval process. If valid section is determined, the system validates the Rowtype. If the valid Rowtype is determined, the system will locate the row index and column index. Then, the data is retrieved from the located row index and column index for further processing.

As illustrated in FIG. 5, the system or module are initiated by receiving input from a database or a user. Then, the system validates the Section and Rowtype based on the receiving input for updating process. If valid section is determined, the system validates the Rowtype. If the valid Rowtype is determined, the system will locate the row index and column index. Then, the data is updated to the located row index and column index based on the input received. Then, the updated data will be stored into a Database.

As illustrated in FIG. 6, the system or module are initiated by retrieving the updated data stored in a Database for uploading process, where the system append the Electronic Document Identifier (eDoc-Identifier) to output. Then, the systems will determine the number of section from the updated data stored in a Database to be assembled. If there is section defined in updated data, the systems will retrieve all the section from the updated data stored in a Database. Then, the system will retrieve all Rowtype for further processing. The system further will validates if there is any other Section or Rowtype defined in the updated data stored for further processing. If there no other Section or Rowtype defined in the input, the system will further proceed to append the retrieved Section, Rowtype and values to be uploaded into a eDoc String.

As illustrated in FIG. 7, the system or module are initiated by receiving input from a database or a user, in which it contains information such as: ledger identifier, document identifier, account 1 and account 2 and eDoc. Then, the system validates with the database if this account is a new account. If it's not a new account, the system retrieves the existing Page from the database for later processing and append eDoc form input to the eDoc from Page. However, if it's a new account, the system validate if the length of the combined eDoc is greater than the Page limit. If the length of the combined eDoc is greater than Page Limit, the system chops the combined eDoc into desired Pages according to predefined Page limit. Otherwise, each Index will be formed based-on document identifier, date, end sequence number, document status, document offset and document length. Then, store Page and Index into database.

As illustrated in FIG. 8, the system or module are initiated by receiving input from a database or a user, in which it contains information such as: document identifier, date, end sequence no, document status, document offset and document length. Then, forming an Index by combining all input as a string and each input is separated by colon (:) and return the formed Index to the system that triggered this operation.

As illustrated in FIG. 9, the system or module are initiated by receiving input from a database or a user, in which it contains information such as: ledger identifier, document identifier, account 1 and account 2. Then, the system retrieves Index (indexes) and DATA of Page 0 for a given or specified account from a eFile stored in the database. Thereafter, parse the Index into individual index for processing. Then, the system retrieves a index that contains document identifier or information from the input received. Then, the system validates if there matching indexes from the input received. If found, the system will extract the offset and the length of the target eDoc and further extract the eDoc from DATA of Page 0. Then, output the extracted eDoc to the database or user requested.

As illustrated in FIG. 10, the system or module are initiated by receiving input from a database or a user, such as source or details of eDoc. Then, parse source eDoc for further processing. Then, identify and load destination eDoc (for later updating). Then, loading predetermined mapping instructions. Then, the system validate if the data of the predetermined source column fulfill the predetermined requirement, if there are more mapping instruction. Then, perform computation on the data of the predetermined source column if there is one more mapping instruction. Therafter, the system will sum up the result from the computation with the data of the predetermined destination column and update the final result to the predetermine destination column. This process will be carried on till there is no more mapping instruction and store the updated destination eDoc back into database. However, if there are no further mapping instruction, the system store the updated destination eDoc back into database.

eDoc Filing System account-centric system that acts as a display, transmission, storage and processing medium from end to end without requiring any other transformation or normalization.

Electronic File (eFile) is an electronic folio (similar to a file in conventional manual filing systems) where all types of documents with different data types can be stored together in an account-centric manner.

The Filing system logically stores all data and information that relate to a single account in an Electronic File (eFile), in chronological order. The Electronic Document (eDoc) are stored as sequential strings of data mapped to a data dictionary, and may include multiple data types in each string (e.g. image files, binary files, comma separated format, XML or any of the nearly 500 data formats in existence today). This allows the storage of any type of data within one record. The way eDoc stores its data provides near real-time data mining without the need for data modeling.

eDoc is a data storage format comprising strings containing multiple rows each preceded by a unique row code: RxxV-Rxx being the row# and V the version#. Multiple rows of data of various rows make an eDoc. All data is stored in variable length or fixed length columns. Each row contains multiple columns separated by terminators. There are special terminators for start and end of DxxV (documents), RxxV (rows), etc. eDoc is designed for change. Various versions of RxxV and DxxV can exist concurrently. eDoc can be converted to XML and vice versa. eDoc is similar to XML as its data also has separators and identifiers and tags, but eDoc has additional system fields that provide new functionality. If required, XML is used as a universal transmission document and passed to other systems, where data can be normalized to tables. The table 1.0 and 2.0 further describes the terminators (separator) and identifiers and tags.

eDoc String
Example of eDoc String—Data Structure: (Store in LxxV)

üDxxVû

üSxxVû

üRID0ûûûûûûûûûûûûûûûûûûûûûûûüRû
üRxxVûûû ... ûûûüRû
...
üRxxVûûû ... ûûûüRû

üSû
...
üSxxVû
...
üSû

üDû

### Terminators (Separator) Coding Structure

TABLE 1.0
Basic Separator

| Code | Separator | Example |
|---|---|---|
| üDxxVû | Start Document | üDJS4û- start of Job sheet |
| üDû | End Document | üDû |
| üSxxVû | Start Section | üS001û- start of 1^{st} Section |
| üSû | End Section | üSû |
| üRxxVû | Start Row | üRNA1û- start of Name/Address Row |
| | | v1 |
| üRû | End Row | üRû |
| û | Field Separator | ûfield-1û . . . ûfield-n |
| ý | SubField Separator | ý sub field-1 ý . . . ý subfield-n |
| ü[ | Open Packet | ü[üDJS1 . . . open packet for subDoc of |
| | | DJS1 |
| ü] | Close Packet | . . . üSûüDûü]close packet for the |
| | | subDoc |

### LDSRC Coding Structure

TABLE 2.0

| Code | Description | Example |
|---|---|---|
| LxxV | Ledger Code | LJS4: Jobsheet Ledger version 4 |
| DxxV | Document Code | DJS4: Jobsheet Document version 4 |
| SxxV | Section Code | S001: Section 1 |
| RxxV | Row Code | RNA5: Name Address Rowtype version 5 |
| CxxV | Column Code | C005: Column 5 |
| VxxV | SubColumn Code | |

The Document Identifier (such as RIDO) will only contain one or the whole Document, in which the Document Identifier is stored in the first Section. The Document Identifier contains details such as creator details, document details, update history, attributes and etc. Furthermore, the eDoc String data structure is also an Nth-dimension data structure where another eDoc String can be encapsulated within the ü[. . . ü] and stored in a Column. The LDSRC Codes is also representing the GIS of an eDoc String stored. To retrieve the eDoc String, the LDSRC Codes are used to locate them.

Example of eDoc String: (Store in LHRO)

üDHR1û

üS001û

üRID0ûdxxvû1ûUûLHR0ûLD08003ûûûDHR1ûCûûûûûûûId1302
EûLeave Applicationû12/12/2013ûûûû,&-. ~~~~ûüRû
üRNA5ûû1ûUûûûûûûûûûûûUploadûûûûûûNurul
AfizabintilbrahimûLot No. 4 LrgKingland 1, TmnKingland Phase
2, 88100 Petagas, KKûMalaysiaûNurulAfizabintilbrahimûDato
Sri MikeûSisterû016-8451196ûûIT
SUPPORTûFizaûûûûûûûûûû8ûSUPPORTûûûûûûûûûû1430996
7û830430-12-5720ûûû454 101 9729û61692683û830430-12-
5720û2000û2500û500ûûûûûûcobraangels@gmail.comûûûûûûû
ûûûûûûûû20Oct08û20Jan09û29/11/2013û28/11/2013ûûûûûûûûû
ûûûûûûûûûûûûûûûûûûûûûûûPETALING JAYAûûûûûûû014
3757463ûûûûûûûûûûûJunior Server
AdministratorûûûûûûûFemaleûûokûokûokûRecommendedûûûû
OTHERSû4.0û12ûûûû11.0û09/12/2013û1ûUûCREATIVEûûûû0
0000036ûProject Loanûûûûû(,′,)~~~ûüRû
üR133ûû1ûûûûûûûûûûûûûûûûû2û2û2013ûûûD318ûALûûûûûûû‘
’,(~~~~ûüRû
üRRpD1ûû1ûûûûûûûûûûûûûûûûûûûûûûûûûûtesting approve
10.40ûûûûûûûûûûûûûûûûûûûûûûûûûûûûûûûûûûûûûûûûûûûûûû
ûûûûûûûû04/12/2013ûûûûûûûûûûûûûûûûûûûûûûûûûûûûûûûûûa
aaaaaaaûûûûûûûûûûûûûûûûûûûûûûûûûûû111ûûûûûûûûûûûûûû
ûûûûûûûûûûûûûûûûûûûûûû*&&-~~~~ûüRû
üR134ûD313û1ûûûûûû1640ûûûûûûûûûûûû1640û2014ûûûûPER
SONALLOANûû

ü[

üDHR1ûüS001ûüRID0ûdxxvû1ûUûLHR0ûLD0800
3ûûûDHR1ûCûûûûûûûId1302EûLeave
Applicationû12/12/2013ûûûû,&-. ~~~~ûüRû
üRR134ûD313û1ûûûûûû1640ûûûûûûûûûûûû1640
û2014ûûûûPERSONALLOANûûûûûûû(‘-
+~~~~ûüRûüSûüDû

ü]

ûûûûû(’-+~~~~ûüRû

üSû

üDû

eDict

As illustrated in FIG. 2, the Electronic Dictionary (eDict) or metadata is used to describe the attribute/behavior of each ledger (LxxV), document (DxxV) and Rowtype (RxxV). For LxxV level, the ledger identifier, eDoc updating methods (FIFO, LIFO, Update or Overwrite) and number of eDoc to be kept in eLedger is predefined in Ledger type eDict. For DxxV level, the document type to be or can be stored is predefined in the Document type eDict. For RxxV level, the Rowtype type eDict is categorized into 3 parts; first, general attributes such as name, data type, data length and so forth; second, display attributes such as font type, size, color and so forth; third, computation attributes like data validation and computation. The table 3.0, 4.0 and 5.0 shows an example of metadata or library predefined for Ledger, Document and Rowtype.

Ledger eDict—Definition

TABLE 3.0
Dictionary

| # | Name | Function | Length | Description |
|---|---|---|---|---|
| 1 | row | data | 4 | RDL0 |
| 2 | doc | data | 4 | Document (DxxV) |
| 3 | sq | data | 4 | Sequence# |
| 4 | st | data | 2 | Status |
| 5 | lg | data | 4 | LD10 |
| 6 | ac1 | data | 16 | Ledger (LXXV) |
| 7 | ac2 | data | 16 | |
| 8 | proj | data | 4 | Project |
| 9 | datatyp | data | 1 | |
| 10 | usg | data | 1 | |
| 11 | opt | data | 1 | |
| 12 | subfield | data | 4 | |
| 13 | nm1 | data | 32 | Ledger name |
| 14 | nm2 | data | 32 | Update method (FIFO/LIFO/U/O) |
| 15 | le | data | 2 | Max document |
| 16 | de | data | 1 | |
| 17 | def | data | 16 | |
| 18 | hid | data | 10 | |
| 19 | htag | data | 4 | |
| 20 | htype | display | 4 | |
| 21 | hstyle | display | 255 | |
| 22 | lig | data | 255 | |
| 23 | dup | entry | 1 | |
| 24 | msk | display | 200 | |
| 25 | cond | compute | 255 | |
| 26 | comp | compute | 255 | |
| 27 | next | compute | 4 | |
| 28 | der | data | | |
| 29 | mnle | validate | 2 | |
| 30 | mxv | validate | 14 | |
| 31 | mnv | validate | | |
| 32 | res1 | reserved | | |
| 33 | res2 | data | 4 | |
| 34 | res3 | reserved | | |
| 35 | res4 | reserved | | |
| 36 | res5 | reserved | | |
| 37 | bal | data | | balance |
| 38 | size | data | | Size of this row |
| 39 | secu | data | 8 | Security |
| 40 | cksum | data | 8 | Checksum |

Document eDict—Definition

TABLE 4.0
Dictionary

| # | Name | Function | Length | Description |
|---|---|---|---|---|
| 1 | row | data | 4 | RDD0 |
| 2 | doc | data | 4 | Document (DxxV) |
| 3 | sq | data | 4 | Sequence# |
| 4 | st | data | 2 | Status |
| 5 | lg | data | 4 | LD10 |
| 6 | ac1 | data | 16 | Doc (DXXV) |
| 7 | ac2 | data | 16 | |
| 8 | proj | data | 4 | Project |
| 9 | datatyp | data | 1 | File type (Excel/Email/bin/eDoc) |
| 10 | usg | data | 1 | |
| 11 | opt | data | 1 | |
| 12 | subfield | data | 4 | |
| 13 | nm1 | data | 32 | Document name |
| 14 | nm2 | data | 32 | |
| 15 | le | data | 2 | Size of Doc |
| 16 | de | data | 1 | Version |
| 17 | def | data | 16 | |
| 18 | hid | data | 10 | |
| 19 | htag | data | 4 | |
| 20 | htype | display | 4 | |
| 21 | hstyle | display | 255 | |
| 22 | lig | data | 255 | |
| 23 | dup | entry | 1 | |
| 24 | msk | display | 200 | |
| 25 | cond | compute | 255 | |
| 26 | comp | compute | 255 | |
| 27 | next | compute | 4 | |
| 28 | der | data | | |
| 29 | mnle | validate | 2 | |
| 30 | mxv | validate | 14 | |
| 31 | mnv | validate | | |
| 32 | res1 | reserved | | |
| 33 | res2 | data | 4 | |
| 34 | res3 | reserved | | |
| 35 | res4 | reserved | | |
| 36 | res5 | reserved | | |
| 37 | bal | data | | balance |
| 38 | size | data | | Size of this row |
| 39 | secu | data | 8 | Security |
| 40 | cksum | data | 8 | Checksum |

Rowtype eDict—Definition

TABLE 5.0
Dictionary

| # | Name | Function | Length | Description |
|---|---|---|---|---|
| 1 | row | data | 4 | RDC0 |
| 2 | doc | data | 4 | Document (DxxV) |
| 3 | sq | data | 4 | Sequence# |
| 4 | st | data | 2 | Status |
| 5 | lg | data | 4 | LD10 |
| 6 | ac1 | data | 16 | RowCol (RxCx) |
| 7 | ac2 | data | 16 | |
| 8 | proj | data | 4 | Project |
| 9 | datatyp | data | 1 | Data (9/A/X/B/D/T) |
| 10 | usg | data | 1 | Usage (C/Blank) |
| 11 | opt | data | 1 | Optional |
| 12 | subfield | data | 4 | Subfield |
| 13 | nm1 | data | 32 | Label |
| 14 | nm2 | data | 32 | Name of column |
| 15 | le | data | 2 | Max Length |
| 16 | de | data | 1 | Decimal (2 dec) |
| 17 | def | data | 16 | Default |
| 18 | hid | data | 10 | HTML ID |
| 19 | htag | data | 4 | HTML Type |
| 20 | htype | display | 4 | # of elements |
| 21 | hstyle | display | 255 | Font, x, y, etc |
| 22 | lig | data | 255 | URL |
| 23 | dup | entry | 1 | Duplicate |
| 24 | msk | display | 200 | Mask |
| 25 | cond | compute | 255 | Condition |
| 26 | comp | compute | 255 | Computation |
| 27 | next | compute | 4 | Tab index |
| 28 | der | data | — | Derived Data |
| 29 | mnle | validate | 2 | Minimum length |
| 30 | mxv | validate | 14 | Maximum value |
| 31 | mnv | validate | | Minimum value |
| 32 | res1 | reserved | | |
| 33 | res2 | data | 4 | Section |
| 34 | res3 | reserved | | |
| 35 | res4 | reserved | | |
| 36 | res5 | reserved | | |
| 37 | bal | data | — | |
| 38 | size | data | — | Size of this row |
| 39 | secu | data | 8 | Security |
| 40 | cksum | data | 8 | Checksum |

Example of eDict Structure

üDDR0û
üS001û
<--------------------- 40 columns in horizontal representation ---------------------------
-->
üRDC0û doc û sq û st û lg û ac1 û ac2 û proj û datatyp û usg û^opt û subfield
û nm1 û nm2 û le û de û def û hid û htag û htype û hstyle û lig û dup û msk û
cond û comp û next û der û mnle û mxv û mnv û res1 û res2 û res3 û res4 û
res5 û bal û size û secuû cksumüRû
üSû
üDû

eLedger

Electronic Ledger (eLedger) is where summaries or derivatives of eFile that is kept in variable length or fixed length format thus allowing for greater flexibility and fast retrieval. The Information in eLedger can be deleted and modified. Each eFile can have multiple eLedgers if required (for speedy reporting purposes). The update method of each eDoc to the eLedger is predefined in eLedger dictionary. The eLedger can contain n copies of eDoc that arrange in FIFO or LIFO manner; or new eDoc can override the exiting eDoc in the eLedger; or the update only manipulate data from certain column(s) in eDoc with the predefine column(s) in eLedger. The system may further include Zero Balancing function where every transaction can be traced and no information is ever deleted, which means everything will be balanced (always balance to last cent). All transactions have a copy in the Transaction Ledger, so changes to any account are immediately verifiable and problems isolated. The system also may make the system naturally SOX Compliant (Sarbanes-Oxley Act of 2002). The system may further include Reverse Processing where a new eLedger can be generated or regenerated from eFile based on new configuration or updated configuration.

As illustrated in FIG. 3, the eLedger contains example customer profile that includes customer details (RNA6—Name and Address Rowtype) and summary of total item such as apple, orange and pear bought daily (R320—32-day Rowtype) and monthly (R130—13-month Rowtype) for year 2014. The summary in the eLedger are populated from the daily transactions in eFile.

### Rowtype Header & Footer

TABLE 6.0

| sq | name | description |
|---|---|---|
| 1 | RxxV | rowtype |
| 2 | RWCD | row code |
| 3 | RWSQ | sequence |
| 4 | RWST | status |
| 5 | RWLG | ledger |
| 6 | RWA1 | account 1 |
| 7 | RWA2 | account 2 |
| 8 | RWCO | company & department |
| . . . | . . . | |
| n + 1 | RWBA | balance |
| n + 2 | RWSZ | size |
| n + 3 | RWSE | security |
| n + 4 | RWCS | checksum |

All Rowtype contains a Header with 8 columns and a Footer with 4 columns as shown on the Table 6 above. The row code (RWCD) of the Rowtype Header indicates its uniqueness among other same Rowtypes that appear within a Section and ledger (RWLG), account 1 (RWA1), account 2 (RWA2) and company & department (RWCO) indicates the location of the Rowtype in the database. The security (RWSE) of the Rowtype Footer is used to ensure that the right user(s) can access this row and the checksum (RWCS) is to ensures the data within the row is not corrupted.

### Subsequent Documents (SubDoc)

As illustrated in FIG. 4, the creation of Subsequent Documents (subDoc), where the system splits a Doc so that it can be debited/credited to relevant account, each subDoc is appended as a string one after another. The Main Doc and subDoc(s) will have the same document identifier. For example, an invoice with document identifier, D232 may have a subDoc to debit customer account and subDoc to credit Apple, Orange and Pear Stock. (Referring to the example in FIG. 2).

### Reserve and Commit

It's a process where a set of predefined requirements have to be adhered before any updating can take place. For example in an invoice, the requirements will be the customer must have sufficient credit to be debited from the account and there must be sufficient stock to be stocked out before the process is committed.

### Header+Index+Data

As illustrated in FIG. 5, the eFiles are stored in a RDBMS table, where the table comprises of Control, Index and Data. The Control section contains key and details about the Page. The Index is used to locate the location of each eDoc in a Page, where the Indexing are done in Horizontal manner to create sub-filing system within a filing system. The Data is where the eFile is stored.

Example of Index for Account 1, Relative Page is as below:
DHRO:20140828: 5: U: 0: 122/DHRO:20140828: 6: U: 122: 250/DHRO:20140828: 7: U: 250: 372/

Each account contains a eFile and the eFile contains number of eDocs. The eFile is chopped into Pages according to Page size before storing into RDBMS. The Page number begins from Relative Page and when a new Page is added, the Relative Page is advanced to Page 1 and the Page number of the newly added Page is 0 and so forth. Besides that, Relative Page is also a relative page to the system; the enquiry will always start from Relative Page.

The Control section may also include the following:
lg—ledger identifier
act1—account 2
lpgn—last page no
ssq—start document sequence no
sln—start Page line no
esq—end document sequence no
eln—end Page line no
date—last updated date
st—the status of the eFile such as deleted
co—company and department
bal—balance of all eDocs

The present invention may be embodied in other specific forms without departing from its essential characteristics. The described embodiments are to be considered in all respects only as illustrative and not restrictive. The scope of the invention is, therefore indicated by the appended claims rather than by the foregoing description. All changes, which come within the meaning and range of equivalency of the claims, are to be embraced within their scope.

1.-16. (canceled)

17. A system to emulate manual filing system by storing and processing a document that operates on a relational database management system, comprising:
a string template having at least one detail of document number, number of sections and number of rows defined based on at least one input;
a string module for generating an electronic document having at least one electronic document header, section or rowtype by validating the document number, number of sections or number of rows based on the string template;
an extraction module for extracting the electronic document having at least one electronic document header, section, rowtype or column for retrieval process;
a retrieval module for retrieving at least one retrieved data from the data of the electronic document stored in the database based on the input of the section, rowtype or column;
an updating module for updating the retrieved data of the electronic document and store at least one updated data to the database based on the input of the section, rowtype or column defined; and
a formation module for forming the updated electronic document by retrieving the updated data based on the input of the section, rowtype or column.

18. The system according to claim 17, further comprising:
a paging module for appending the electronic document in the database into at least one electronic file according to a predefined page limit; and
an index module for forming at least one index to the electronic file based-on document identifier, date, end sequence number, document status, document offset or document length.

19. The system according to claim 18, further comprising:
a read module for retrieving the index and at least one data page zero of the electronic file based on at least one read input to at least one output.

20. The system according to claim 19, further comprising:
a mapping module for updating at least one retrieved data based on at least one mapping input by determining the electronic file using the read module to retrieve the retrieved data of the electronic document using the retrieval module, in which the updating module updates the retrieved data to the database and forming the retrieved data into the electronic document using the formation module for updating into the electronic file using the paging module and forming the index using the index module.

21. The system according to claim 20, wherein the mapping input further comprises:
at least one mapping instruction having a predefined mapping instruction; and
at least one source data for updating the retrieved data of the electronic document.

22. A method to emulate manual filing system by storing and processing a document that operates on the relational database management system, comprising the steps of:
creating a template using a string template by defining a new document and indicate number of sections and number of rows required, which will be defined by an input from a user or a database;
generating an electronic document having at least one electronic document header, section or rowtype by validating the document number, number of sections and number of rows based on the string template; and
extracting the electronic document having at least one electronic document header, section or rowtype for retrieval process using an extraction module.

23. The method according to claim 22, wherein the step of extracting the electronic document header further comprises the steps of:
validating if there is a section defined in the input;
creating a new section and defining or classifying the section if it is a first section in the input;
validating if there is any rowtype defined in the input, if there is a rowtype defined in the input;
creating a new rowtype based on a predefined dictionary, if there is a rowtype defined in the input;
validating if there is any other section or rowtype defined in the input for further processing; and
generating an electronic document template string with a document number, if there no other section or rowtype defined in the input.

24. The method according to claim 23, further comprising the steps of:
retrieving at least one retrieved data from the data of the electronic document stored in the database based on at least one input of the section, rowtype or column using a retrieval module;
updating the retrieved data of the electronic document and storing at least one updated data to the database based on the input of the section, rowtype or column defined using an updating module; and
forming the updated electronic document by retrieving the updated data based on the input of the section, rowtype or column using a formation module;
wherein retrieving an electronic document string using the retrieval module comprises the steps of:
validating if there is a section defined in the electronic document;
splitting the section into rowtype for further processing;
splitting the rowtype into a column of data; and
storing the column of data into the database.

25. The method according to claim 24, wherein the step of storing the column of data into the database further comprises the steps of:
validating if there is any other section or rowtype defined in the input for further processing;
validating if there is no other section or rowtype defined in the input; and
processing for retrieval of data in the column.

26. The method according to claim 24, wherein the step of validating the section or rowtype using the updating module further comprises the steps of:
validating if a valid section is determined;
validating if a valid rowtype is determined;
locating a row index and column index;
updating to the located row index and column index based on the input received; and
storing the updated data into the database.

27. The method according to claim 22, wherein the step of storing and processing the document that operates on the relational database management system further comprises the steps of:
appending the electronic document in the database into at least one electronic file according to a predefined page limit using a paging module; and
forming at least one index to the electronic file based on a document identifier, date, end sequence number, document status, document offset or document length using an index module.

28. The method according to claim 27, wherein the step of storing and processing the document that operates on the relational database management system further comprises the steps of:
retrieving the index and at least one data page zero of the electronic file based on at least one read input to at least one output using a read module.

29. The method according to claim 28, wherein the step of storing and processing the document that operates on the relational database management system further comprises the steps of:
updating at least one retrieved data using a mapping module based on at least one mapping input by determining the electronic file using the read module to retrieve the retrieved data of the electronic document using the retrieval module, in which the updating module updates the retrieved data to the database and forming the retrieved data into the electronic document using the formation module for updating into the electronic file using the paging module and forming the index using the index module.

30. The method according to claim 29, wherein the step of mapping input further comprises the steps of:
defining the electronic file location using at least one mapping instruction having the predefined mapping instruction; and
updating the retrieved data of the electronic document using at least one source data.
